(19) United States
(12) Patent Application Publication
(10) Pub. No.: US 2019/0042543 A1
(43) Pub. Date: Feb. 7, 2019

(54) MATRIX DECOMPOSITION DEVICE AND MATRIX DECOMPOSITION METHOD

(71) Applicant: FUJITSU LIMITED, Kawasaki-shi (JP)

(72) Inventor: Makiko Konoshima, Kawasaki (JP)

(73) Assignee: FUJITSU LIMITED, Kawasaki-shi (JP)

(21) Appl. No.: 16/043,587

(22) Filed: Jul. 24, 2018

(30) Foreign Application Priority Data
Aug. 2, 2017 (JP) 2017-150278

(51) Int. Cl. G06F 17/16; G06F 7/58

(52) U.S. Cl. CPC G06F 17/16; G06F 7/588

(57) ABSTRACT

A matrix decomposition device extracts information on positions where elements become 1 in a matrix having, as an element, an absolute value of a difference obtained by subtracting a product of an updated first matrix and an updated second matrix from the matrix as the decomposition target, and determines a number of trials to change spins based on a ranking number and the information on the positions, calculates an updated energy function based on the updated first matrix and the updated second matrix according to the generated energy function, as many times as a predetermined iteration count, changes a spin of a first matrix corresponding to selected column number information, and a spin of a second matrix corresponding to selected row number information, respectively, calculates a changed energy value by using the changed spin of the first matrix and the changed spin of the second matrix.

### CROSS-REFERENCE TO RELATED APPLICATION

This application is based upon and claims the benefit of priority of the prior Japanese Patent Application No. 2017-150278, filed on Aug. 2, 2017, the entire contents of which are incorporated herein by reference.

### FIELD

The embodiments discussed herein are related to a matrix decomposition device and a matrix decomposition method.

### BACKGROUND

There is known a technique related to calculation of decomposing a non-negative matrix whose element value satisfies a system such as Boolean algebra. For example, there is known a technique of extending the calculation of decomposing a non-negative matrix to decomposition of a binary matrix. In the corresponding technique, each component of the binary matrix is converted to a continuous value once, and then re-converted to a binary value.

Related technologies are disclosed in, for example, Japanese Laid-Open Patent Publication Nos. 09-231197, and 08-235150.

Related technologies are disclosed in, for example, Zhongyuan Zhang, Tao Li, Chris Ding, and Xangsun Zhang. “Binary Matrix Factorization with applications.” Data Mining, 2007. ICDM 2007. Seventh IEEE International Conference. 2007, and Daniel D. Lee and H. Sebastian Seung. “Algorithms for Non-negative Matrix Factorization.” Advances in Neural Information Processing Systems 13 (NIPS 2000). 2000.

### SUMMARY

According to an aspect of the invention, a matrix decomposition device configured to decompose a matrix as a decomposition target into a first factor matrix and a second factor matrix, the matrix decomposition device includes a memory, and a processor coupled to the memory and the processor configured to generate an energy function based on the matrix as the decomposition target, determine a temperature at which annealing is performed, based on an initial value of the temperature, extract information on a plurality of positions where elements become 1 in a matrix having, as an element, an absolute value of a difference obtained by subtracting a product of an updated first matrix and an updated second matrix from the matrix as the decomposition target, and determine a number of trials to change spins based on a ranking number and the information on the plurality of positions, calculate an updated energy function based on the updated first matrix and the updated second matrix according to the generated energy function, as many times as a predetermined iteration count, change a spin of a first matrix corresponding to selected column number information, and a spin of a second matrix corresponding to selected row number information, respectively, calculate a changed energy value by using the changed spin of the first matrix and the changed spin of the second matrix, when the changed energy value is smaller than an updated energy value, repeat updating the updated energy value with the changed energy value, the first matrix including the changed spin of the first matrix, with the updated first matrix, and the second matrix including the changed spin of the second matrix, with the updated second matrix, respectively, and when the product of the updated first matrix and the updated second matrix is equal to the matrix as the decomposition target, set the updated first matrix as the first factor matrix, and the updated second matrix as the second factor matrix, and repeat selecting information on one selected column number from information of a plurality of column numbers included in the information on the plurality of positions, and selecting information on one selected row number from information of a plurality of row numbers included in the information on the plurality of positions, as many times as the number of trials.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view illustrating an example of input/output in a first embodiment;

FIG. 2 is a view illustrating an example of a matrix decomposition device in the first embodiment;

FIG. 3A is a flowchart illustrating an example of a matrix decomposition processing in the first embodiment;

FIG. 3B is a flowchart illustrating an example of the matrix decomposition processing in the first embodiment;

FIG. 4 is a view illustrating an example of a matrix decomposition processing result in the first embodiment;

FIG. 5 is a view illustrating an example of a change target spin in a second embodiment;

FIG. 6 is a view illustrating an example of a matrix decomposition processing progress in the second embodiment;

FIG. 7 is a flowchart illustrating an example of a change spin selecting process in the second embodiment;

FIG. 8 is a view illustrating an example of comparison of matrix decomposition processing speeds;

FIG. 9 is a view illustrating examples of an energy function generation processing in a third embodiment;

FIG. 10 is a view illustrating an example of a matrix decomposition processing progress in the third embodiment;

FIG. 11 is a view illustrating examples of a public key and a secret key in a fourth embodiment;

FIG. 12 is a flowchart illustrating an example of a decryption process in the fourth embodiment;

FIG. 13 is a flowchart illustrating an example of a change spin selecting process in a fifth embodiment;

FIG. 14 is a flowchart illustrating an example of a random number generation process in the fifth embodiment;

FIG. 15 is a view illustrating an example of a random number generation result in the fifth embodiment;

FIG. 16 is a flowchart illustrating an example of a temperature calculation process in the fifth embodiment; and

FIG. 17 is a view illustrating an example of a hardware configuration of a matrix decomposition device.

### DESCRIPTION OF EMBODIMENTS

The technique of extending calculation of decomposing a non-negative matrix to decomposition of a binary matrix involves conversion of each component of the binary matrix into a continuous value and re-conversion into a binary value, and thus, an inconsistency of elements is likely to occur between a matrix as a decomposition target and a product of factor matrices.

Hereinafter, embodiments of a technique capable of suppressing an inconsistency of elements will be described in detail with reference to the accompanying drawings. The present disclosure is not limited by the embodiments. The embodiments to be described below may be properly combined with each other within a range not causing contradiction.

### First Embodiment

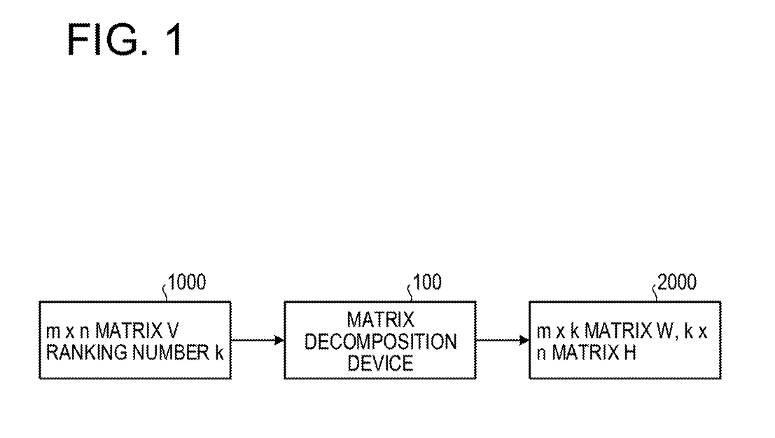

As illustrated in FIG. 1, a matrix decomposition device 100 in this embodiment decomposes an m×n matrix V as an original matrix into a m×k matrix W and a k×n matrix H by, for example, a simulated/annealing process. FIG. 1 is a view illustrating an example of input/output in the first embodiment. As illustrated in FIG. 1, the matrix decomposition device 100 in this embodiment accepts an input of the m×n matrix V and a ranking number k (1000). The matrix decomposition device 100 decomposes the input matrix V with m rows and n columns, and outputs two factor matrices (2000), that is, a matrix W with m rows and k columns and a matrix H with k rows and n columns. The matrix V is an example of a decomposition target matrix, the matrix W is an example of a first factor matrix, and the matrix H is an example of a second factor matrix. When expressed without distinction, the first factor matrix and the second factor matrix may be simply expressed as “factor matrices.” An original matrix and a factor matrix in this embodiment are, for example, non-negative matrices whose element values satisfy a Boolean algebra system.

When outputting the matrix W and the matrix H, the matrix decomposition device 100 in this embodiment sets a first matrix and a second matrix including a hypothetical value “spin.” In the following, a matrix including a spin may be described as a “candidate matrix.” The matrix decomposition device 100 calculates a product of two matrices to calculate a difference between the product of the two matrices and the matrix V as the original matrix. When the product of the two matrices and the original matrix do not coincide with each other, the matrix decomposition device 100 repeats calculation of the product of the two matrices, and comparison with the matrix V as the original matrix while changing the spin included in each of the two matrices. That is, the matrix decomposition device determines the number of trials to change spins as matrices based on the number of elements in which a product of factor matrices does not coincide with an original matrix, and determines an energy value by repeating changing of each of the spins as many times as the number of trials. This may suppress inconsistency of elements.

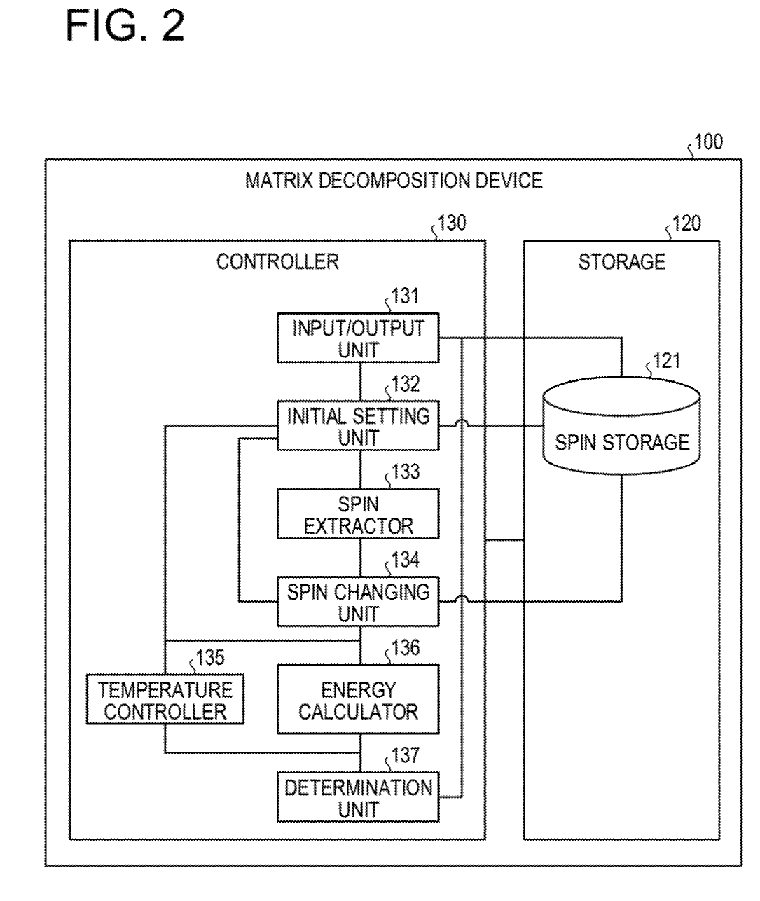

Next, descriptions will be made on an example of the matrix decomposition device in this embodiment with reference to FIG. 2. FIG. 2 is a view illustrating an example of the matrix decomposition device in the first embodiment. As illustrated in FIG. 2, the matrix decomposition device 100 in this embodiment includes a storage 120 and a controller 130. The matrix decomposition device 100 in this embodiment is, for example, a computer such as a server computer, which accepts a request from a terminal device (not illustrated) through a communication unit (not illustrated), and performs a processing, but is not limited thereto. The matrix decomposition device 100 may be, for example, a standalone-type computer such as a personal computer, or a portable computer such as a smart phone, a tablet, or a notebook computer.

The storage 120 stores, for example, various data such as a program executed by the controller 130. The storage 120 includes a spin storage 121. The storage 120 corresponds to a semiconductor memory device such as a random access memory (RAM), a read only memory (ROM), or a flash memory, or a storage device such as a hard disk drive (HDD).

The spin storage 121 stores information on spins. The spin storage 121 stores, for example, spins included in two candidate matrices, in the form of matrices. The information stored in the spin storage 121 is set by an initial setting unit 132 to be described below, and updated by a spin changing unit 134 to be described below.

Then, the controller 130 is a processor in charge of the overall processing of the matrix decomposition device 100. The controller 130 is implemented by, for example, a central processing unit (CPU) or a micro processing unit (MPU), when a program stored in an internal storage device is executed using a RAM as a work area. The controller 130 may be implemented by, for example, an integrated circuit such as an application specific integrated circuit (ASIC) or a field programmable gate array (FPGA).

The controller 130 includes an input/output unit 131, the initial setting unit 132, a spin extractor 133, the spin changing unit 134, a temperature controller 135, an energy calculator 136, and a determination unit 137. The input/output unit 131, the initial setting unit 132, the spin extractor 133, the spin changing unit 134, the temperature controller 135, the energy calculator 136, and the determination unit 137 are examples of electronic circuits included in a processor or examples of processes executed by the processor.

The input/output unit 131 accepts input of, for example, an original matrix V and outputs, for example, factor matrices W and H. For example, the input/output unit 131 accepts input of the matrix V as an original matrix and a ranking number k through, for example, a communication unit or an input device (not illustrated), and outputs the matrix V and the ranking number k to the initial setting unit 132. The input/output unit 131 outputs the factor matrices output from the determination unit 137 through, for example, a communication unit or an input device (not illustrated).

The initial setting unit 132 sets various information used for performing a matrix decomposition processing. When accepting the input of the matrix V and the ranking number k from the input/output unit 131, the initial setting unit 132 specifies a size (m and n) of the matrix V so as to set initial values W0 and H0 of spins which become elements of the matrix W with m rows and k columns and the matrix H with k rows and n columns, and store the initial values W0 and H0 in the spin storage 121. The initial setting unit 132 sets an initial value T0 of a temperature used for a simulated/annealing process, and a total iteration count itermax which is a maximum value of an iteration count when the simulated/annealing process is repeated. Further, the initial setting unit 132 generates an energy function E. The initial setting unit 132 is an example of a function generator.

The initial setting unit 132 sets, for example, all spins to “0” or “1” as the initial value W0 of the matrix W. Likewise, the initial setting unit 132 sets, for example, all spins to “0” or “1” as the initial value H0 of the matrix H

The initial setting unit 132 sets an absolute temperature, for example, 10̂9 as the initial value T0 of the temperature. The initial setting unit 132 sets the number of times, for example, a million times to a billion times as the maximum value itermax of the iteration count. The initial setting unit 132 sets, for example, the energy function E as expressed by the following equation (1).

$$E = {\sum }_{ij} {( {V}_{ij} - {( W ° H )}_{ij} )}^{2} \qquad ( 1 )$$

In equation (1), “Vᵢⱼ” represents an element at the ith row and the jth column of the matrix V, and the symbol “º” represents the operation of the matrix in the Boolean algebra. That is, “(WºH)ᵢⱼ” represents an element at the ith row and the jth column of a matrix product of the matrix W and the matrix H.

Meanwhile, in the operation of the element Vᵢⱼ satisfying the Boolean algebra system, Vᵢⱼ̂2=Vᵢⱼ. That is, the value obtained by squaring an element is equal to the original element, and thus, the equation (1) may be transformed into the following equation (2).

$$\begin{matrix}E = {\sum }_{ij} ( {V}_{ij}^{2} + {( W ° H )}_{ij}^{2} - 2 {{V}_{ij} ( W ° H )}_{ij} ) \\ = {\sum }_{ij} ( {V}_{ij} + {( W ° H )}_{ij} - 2 {{V}_{ij} ( W ° H )}_{ij} ) \\ = {\sum }_{ij} ( ( 1 - 2 {V}_{ij} ) {( W ° H )}_{ij} + {V}_{ij} )\end{matrix} \qquad ( 2 )$$

Equations (1) and (2) represent a matrix having, as an element, an absolute value of a difference between a product of the matrix W and the matrix H and the original matrix V. That is, in this embodiment, as the energy function E, a matrix which has, as an element, an absolute value of a difference between the product of the matrix W and the matrix H and the original matrix V is used.

Next, in the matrix decomposition processing, the spin extractor 133 selects spins to be changed and at the same time, sets the number of trials which is the number of times the changing of the spins is repeated. The spin extractor 133 is an example of a selector.

The spin extractor 133 detects, for example, elements “deltaV” in a difference matrix between a product “WºH” of candidate matrices and the original matrix V. The spin extractor 133 extracts the positions N of elements having “1” as deltaV. The spin extractor 133 outputs a row number Nw and a column number Nh of the extracted N to the spin changing unit 134.

The spin extractor 133 sets, for example, an arbitrary value “p” as the number of candidates to be extracted. When the number of the positions N of elements exceeds p, the spin extractor 133 selects and extracts p positions among the positions N of elements. When the number of the positions N of elements is p or less, the spin extractor 133 selects and extracts all the positions N of elements.

The spin extractor 133 sets, for example, the number of trials Nd based on the set “p,” and outputs the number of trials Nd to the spin changing unit 134. The number of trials Nd is calculated by “2×k×p.”

The spin extractor 133 outputs the row numbers Nw and column numbers Nh of the extracted N's to the spin changing unit 134. For example, the spin extractor 133 outputs the row numbers Nw1 to Nwp of the extracted N's, and column numbers Nh1 to Nhp of N's, to the spin changing unit 134. The spin extractor 133 repeats a processing of selecting and outputting Nw and Nh, Nd times.

The spin changing unit 134 specifies spins to be changed and changes the spins. Upon accepting the output of Nw1 to Nwp and Nh1 to Nhp from the spin extractor 133, the spin changing unit 134 selects, for example, any one position Nwx and Nhx. The spin changing unit 134 selects a row and a column of the spins to be changed by using, for example, a uniform random number. The spin changing unit 134 changes an element value of the selected position. When the element value of the selected position is “0,” for example, the spin changing unit 134 changes the value to “1,” and when the value is “1,” the spin changing unit 134 changes the value to “0.” Then, the spin changing unit 134 outputs candidate matrices W and H including the changed spins to the energy calculator 136.

The temperature controller 135 calculates a temperature used for the simulated/annealing process. By using the initial value T0 of the temperature which is output from the initial setting unit 132, the temperature controller 135 calculates the temperature and outputs the temperature to the determination unit 137. The temperature controller 135 calculates the temperature by using, for example, the following equation (3). The temperature controller 135 is an example of a temperature determination unit.

T=T₀/log(iter) (3)

The energy calculator 136 calculates an energy by using the energy function E. When accepting the output of the initial values W0 and H0 of spins of the candidate matrices from the initial setting unit 132, the energy calculator 136 calculates an energy initial value Eprev. The energy calculator 136 calculates the energy initial value Eprev by substituting W0 and H0 into the energy function E as expressed by equation (2). Then, the energy calculator 136 outputs the calculated Eprev to the determination unit 137.

Upon accepting the output of spins of the updated candidate matrices from the initial setting unit 132, the energy calculator 136 calculates an energy Eafter. The energy calculator 136 calculates the energy Eafter by substituting the spins of the updated candidate matrices into the energy function E as expressed by equation (2). Then, the energy calculator 136 outputs the calculated Eafter to the determination unit 137.

The determination unit 137 compares the spin energy Eafter of the updated candidate matrices to the spin energy initial value Eprev of the candidate matrices before updated. The spin changing unit 134, the energy calculator 136, and the determination unit 137 are examples of a calculator.

When determining that Eafter is smaller than Eprev, the determination unit 137 substitutes Eprev with Eafter. Meanwhile, when determining that Eafter is equal to or greater than Eprev, the determination unit 137 calculates a probability P by using, for example, the following equation (4).

$$P = {e}^{\frac{∠𝔼}{T}} \qquad ( 4 )$$

Then, the determination unit 137 generates a uniform random number M between 0 to 1, and compares the random number M to the probability P. When the random number M is larger than the probability P, the determination unit 137 substitutes Eprev with Eafter. Meanwhile, when the random number M is equal to or less than the probability P, the determination unit 137 rejects changing of spins Wmin and Hmin.

Next, the determination unit 137 determines whether a product WminHmin of the spins Wmin and Hmin coincides with the original matrix V. For example, the determination unit 137 compares a product WminºHmin by Boolean algebra of Wmin and Hmin to the original matrix V. When V and WminºHmin coincide with each other, the determination unit 137 outputs Wmin and Hmin as factor matrices to the input/output unit 131.

Meanwhile, when V and WminºHmin do not coincide with each other, the determination unit 137 determines whether the number of spin selections has reached the number of trials Nd. When it is determined that the number of spin selections has not reached the number of trials Nd, the determination unit 137 causes spin changing unit 134 to repeat a processing of changing spins.

When the number of spin selections has reached the number of trials Nd, the determination unit 137 increments an iteration count iter and determines whether iter has reached the total iteration count itermax. When it is determined that iter has not reached the total iteration count itermax, the determination unit 137 causes the temperature controller 135 to repeat a processing of calculating a temperature T. Meanwhile, when it is detemrined that iter has reached the total iteration count itermax, the determination unit 137 ends the process. When the process is ended, Wmin and Hmin may be output as matrices approximating the factor matrices W and H.

[Processing Flow]

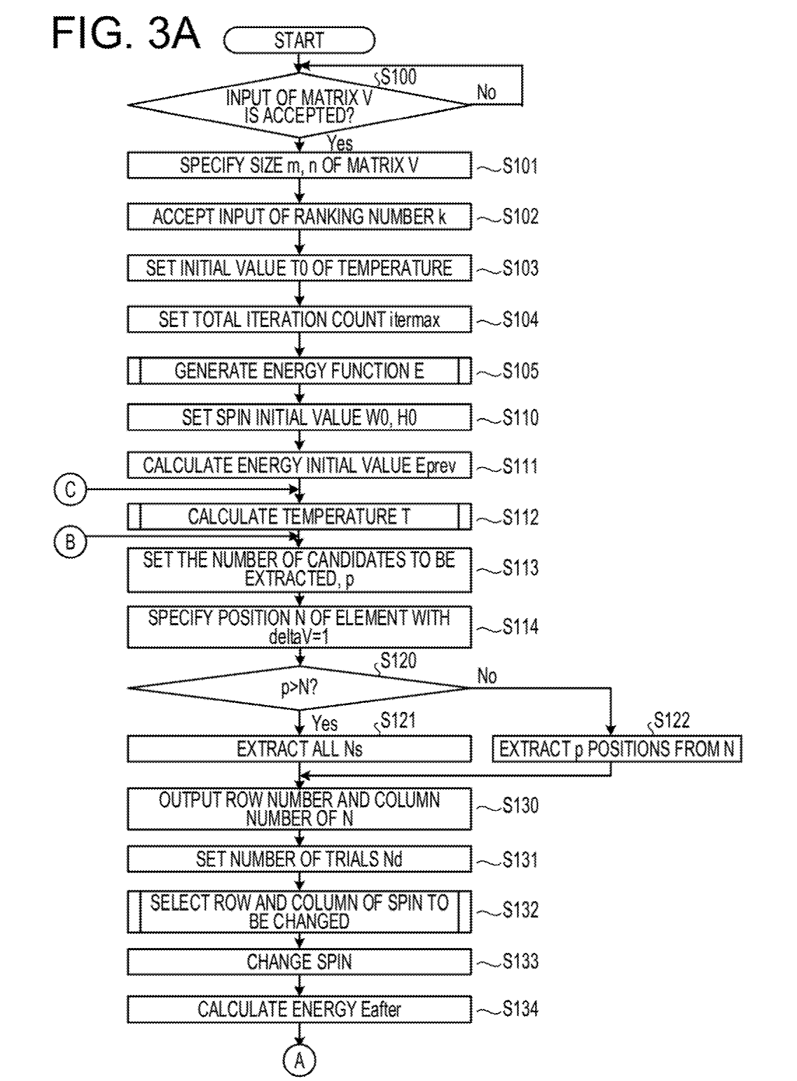

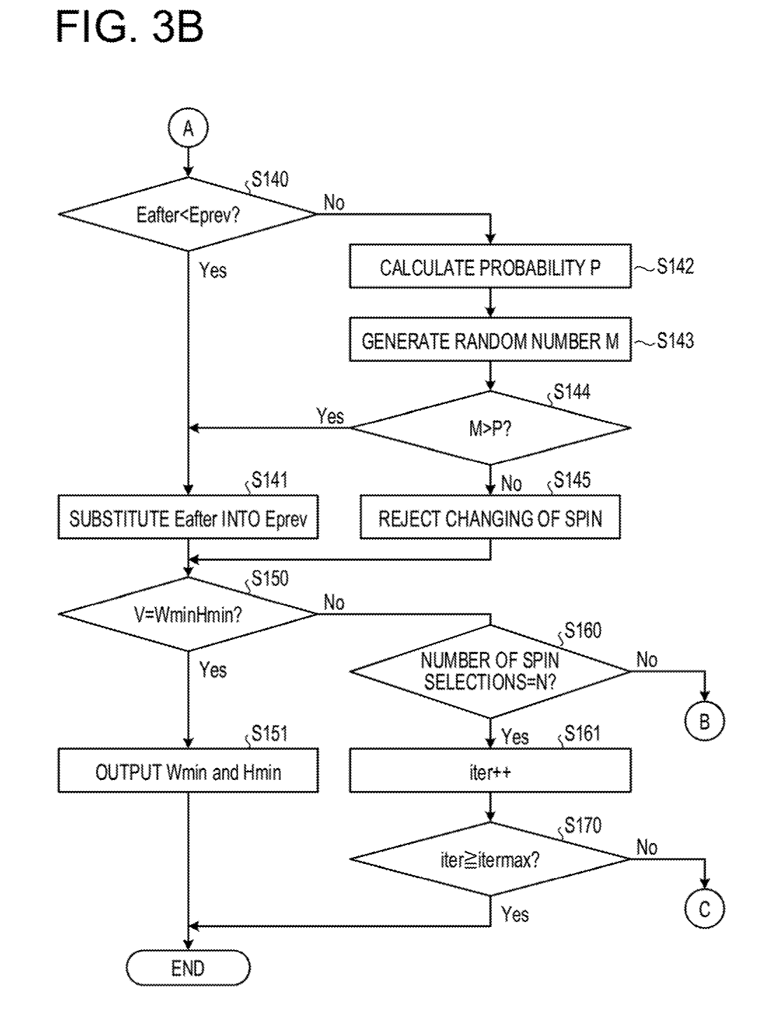

Hereinafter, the process in this embodiment will be described with reference to FIGS. 3A and 3B. FIG. 3A is a flowchart illustrating an example of the matrix decomposition processing in the first embodiment. As illustrated in FIG. 3A, the input/output unit 131 of the matrix decomposition device 100 waits until accepting an input of a matrix V through, for example, a communication unit or an input device (not illustrated) (S100: “No”).

When it is determined that the input of the matrix V has been accepted (S100: “Yes”), the input/output unit 131 outputs the matrix V to the initial setting unit 132. The initial setting unit 132 specifies a size (m and n) of the matrix V (S101).

Next, the input/output unit 131 accepts an input of a ranking number k, and outputs the ranking number k to the initial setting unit 132 (S102). The initial setting unit 132 sets an initial value T0 of a temperature and outputs the initial value T0 to the temperature controller 135 (S103). Then, the initial setting unit 132 sets a total iteration count itermax and outputs the total iteration count itermax to the determination unit 137 (S104).

The initial setting unit 132 generates an energy function E (S105). Then, the initial setting unit 132 sets initial values W0 and H0 of spins and outputs the initial values W0 and H0 together with the energy function E and the matrix V to the spin extractor 133 and the energy calculator 136 (S110).

The energy calculator 136 calculates an initial value Eprev of an energy by using the initial values W0 and H0 of the spins, the matrix V, and the energy function E (S111). Then, the temperature controller 135 calculates a temperature T by using T0 and an iteration count iter (S112).

Thereafter, the spin extractor 133 sets p as the number of candidates to be extracted (S113). Then, the spin extractor 133 detects elements “deltaV” in a difference matrix between a product “W° H” of candidate matrices and the original matrix V. The spin extractor 133 extracts positions N of elements having “1” as deltaV (S114).

Then, the spin extractor 133 determines whether the number of the positions N of elements is less than p (S120). When it is determined that the number of the positions N of elements is less than p (S120: “Yes”), the spin extractor 133 extracts all N's (S121), and proceeds to S130. Meanwhile, when it is determined that the number of the positions N of elements is p or more (S120: “No”), the spin extractor 133 extracts p positions among the positions N of elements (S122), and proceeds to S130.

Then, the spin extractor 133 outputs row numbers Nw and column numbers Nh of the extracted N's to the spin changing unit 134 (S130). The spin extractor 133 sets, for example, the number of trials Nd based on the set number of candidates to be extracted, p, and outputs the number of trials Nd to the spin changing unit 134 (S131).

Subsequently, the spin changing unit 134 selects a row and a column of spins to be changed (S132). For example, the spin changing unit 134 selects a row and a column of the spins to be changed by using a uniform random number. The spin changing unit 134 changes an element value of the selected position (S133). Then, the energy calculator 136 calculates an energy Eafter (S134), and proceeds to S140 through a terminal A.

FIG. 3B is a flowchart illustrating an example of the matrix decomposition processing in the first embodiment. As illustrated in FIG. 3B, the determination unit 137 determines whether Eafter is smaller than Eprev (S140). When it is determined that Eafter is smaller than Eprev (S140: “Yes”), the determination unit 137 substitutes Eprev with Eafter (S141), and proceeds to S150.

Meanwhile, when it is determined that Eafter is equal to or greater than Eprev (S140: “No”), the determination unit 137 calculates a probability P (S142). Then, the determination unit 137 generates a random number M (S143), and determines whether the random number M is larger than the probability P (S144).

When it is determined that the random number M is larger than the probability P (S144: “Yes”), the determination unit 137 proceeds to S 141. Meanwhile, when it is determined that the random number M is equal to or less than the probability P (S144: “No”), the determination unit 137 rejects changing of spins Wmin and Hmin (S145), and proceeds to S150.

Next, the determination unit 137 determines whether a product WminHmin of the spins Wmin and Hmin coincides with the original matrix V (S150). When it is determined that the original matrix V and the product WminHmin coincide with each other (S150: “Yes”), the determination unit 137 outputs Wmin and Hmin to the input/output unit 131. Then, the input/output unit 131 outputs Wmin and Hmin as factor matrices (S151), and ends the process.

Meanwhile, when it is determined that the original matrix V and the product WminHmin do not coincide with each other (S150: “No”), the determination unit 137 determines whether the number of spin selections has reached the number of trials Nd (S160). When it is determined that the number of spin selections has not reached the number of trials Nd (S160: “No”), the determination unit 137 returns to S113 through a terminal B, and repeats the process.

When it is determined that the number of spin selections has reached the number of trials Nd (S160: “Yes”), the determination unit 137 increments an iteration count iter by 1 (S161). Then, the determination unit 137 determines whether the iteration count iter has reached the total iteration count itermax (S170).

When it is determined that the iteration count iter has not reached the total iteration count itermax (S170: “No”), the determination unit 137 returns to S112 through a terminal C, and repeats the process. Meanwhile, when it is determined that the iteration count iter has reached the total iteration count itermax (S170: “Yes”), the determination unit 137 ends the process.

[Effect]

As described above, the matrix decomposition device in this embodiment decomposes a matrix as a decomposition target into a first factor matrix and a second factor matrix. The matrix decomposition device generates an energy function based on the matrix as the decomposition target. The matrix decomposition device determines a temperature at which annealing is performed, based on an initial value of the temperature. The matrix decomposition device extracts information on a plurality of positions where elements become 1 in a matrix having, as an element, an absolute value of a difference obtained by subtracting a product of an updated first matrix and an updated second matrix from the matrix as the decomposition target. The matrix decomposition device determines the number of trials to change spins based on a ranking number and the information on the plurality of positions. The matrix decomposition device calculates an updated energy function based on the updated first matrix and the updated second matrix according to the generated energy function, as many times as a predetermined iteration count. The matrix decomposition device changes a spin of a first matrix corresponding to selected column number information, and a spin of a second matrix corresponding to selected row number information, respectively. The matrix decomposition device calculates a changed energy value by using the changed spin of the first matrix and the changed spin of the second matrix. When the changed energy value is smaller than an updated energy value, the matrix decomposition device repeats updating the updated energy value with the changed energy value, the first matrix including the changed spin of the first matrix, with the updated first matrix, and the second matrix including the changed spin of the second matrix, with the updated second matrix, respectively. When the product of the updated first matrix and the updated second matrix is equal to the matrix as the decomposition target, the matrix decomposition device sets the updated first matrix as the first factor matrix, and the updated second matrix as the second factor matrix. The matrix decomposition device repeats selecting information on one selected column number from information of a plurality of column numbers included in the information on the plurality of positions, and selecting information on one selected row number from information of a plurality of row numbers included in the information on the plurality of positions, as many times as the number of trials. This may suppress inconsistency of elements.

The matrix decomposition device in this embodiment selects the information on the selected column number based on a random number, and selects the information on the selected row number based on a random number. Further, when the changed energy value is larger than the updated energy value, the matrix decomposition device in this embodiment generates a random number by using the temperature determined by a temperature determination unit, at which the annealing is performed. When the random number is equal to or greater than a predetermined probability value, the matrix decomposition device updates the updated energy value with the changed energy value. When the random number is equal to or greater than the predetermined probability value, the matrix decomposition device updates the first matrix including the changed spin of the first matrix with the updated first matrix, and the second matrix including the changed spin of the second matrix, with the updated second matrix, respectively. Accordingly, it is possible to theoretically calculate a global optimal solution without falling into a local optimal solution.

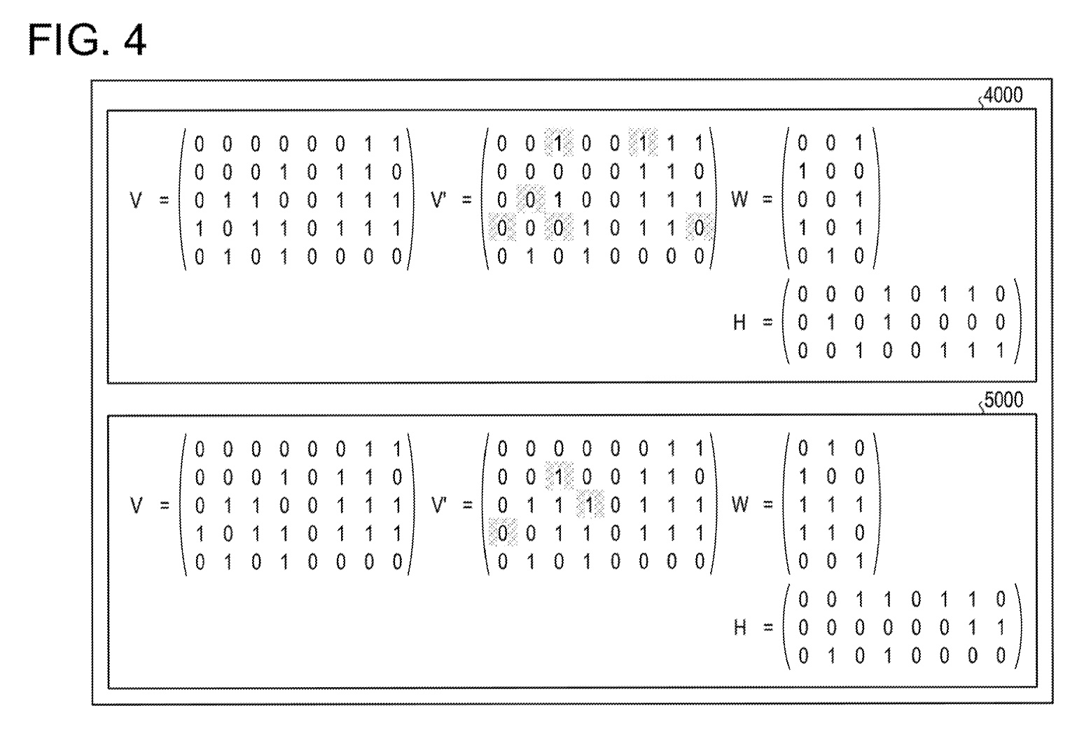

Descriptions will be made on the effect of the use of the matrix decomposition device 100 in this embodiment with reference to FIG. 4. FIG. 4 is a view illustrating an example of a matrix decomposition processing result in the first embodiment. FIG. 4 illustrates an example of a matrix decomposition processing result 4000 in the background art, and an example of a matrix decomposition processing result 5000 in this embodiment. In FIG. 4, a matrix V′ represents a product of the candidate matrix W and the candidate matrix H. Among elements of the matrix V′, shaded elements indicate elements in which an inconsistency occurs between the matrix V and the matrix V′.

As illustrated in FIG. 4, in the matrix decomposition processing result 4000 in the background art, the inconsistency occurs in six elements. Meanwhile, in the matrix decomposition processing result 5000 in this embodiment, the number of elements in which the inconsistency occurs is fixed as three. In this manner, in this embodiment, the inconsistency of elements in the matrix decomposition processing may be suppressed.

### Second Embodiment

In the matrix decomposition processing using the simulated/annealing process as described with the first embodiment, there is an advantage in that it is possible to theoretically calculate a global optimal solution without falling into a local optimal solution, but a calculation amount may become enormous. Therefore, in this embodiment, descriptions will be made on a matrix decomposition processing in which a calculation amount may be reduced.

A matrix decomposition device 200 in this embodiment determines spins to be changed, not based on a random number, but based on a difference between a matrix as a decomposition target and a product of factor matrices. In the following, the spins to be changed may be simply referred as “change spins.” The matrix decomposition device 200 may be implemented by the same configuration as the matrix decomposition device 100 as illustrated in FIG. 2, and thus, detailed descriptions thereof will be omitted.

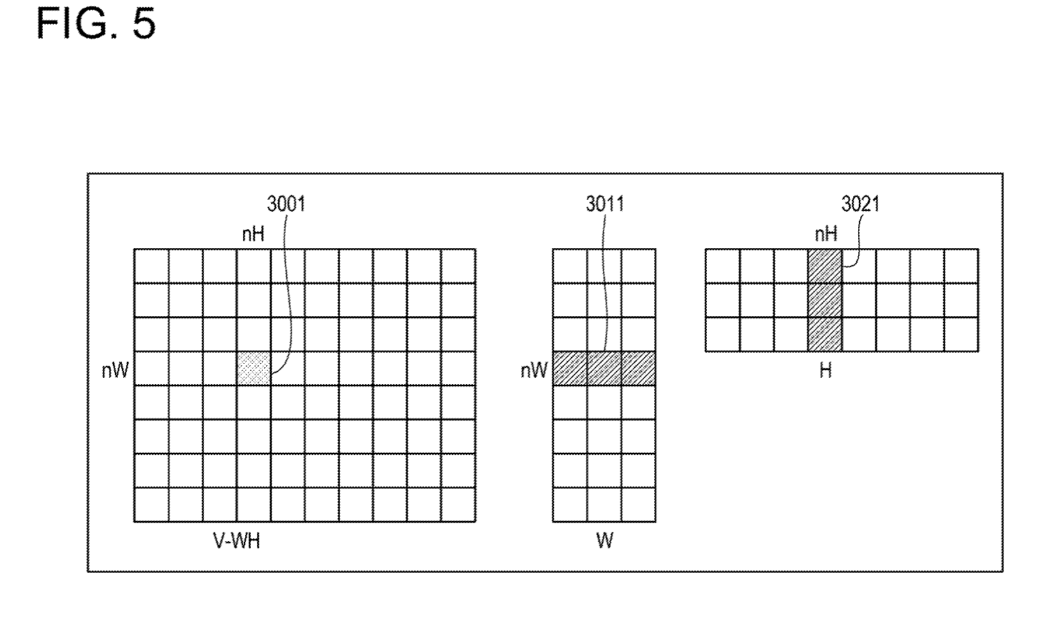

A selection of spins to be changed in this embodiment will be described with reference to FIG. 5. FIG. 5 is a view illustrating an example of a change target spin in the second embodiment. In FIG. 5, an element 3001 indicates an element in which a difference occurs, among elements “deltaV” in a difference matrix between a product “WºH” of candidate matrices and an original matrix V, for example, an element (nW, nH) having 1 as deltaV (deltaV=1). In this case, the matrix decomposition device 200 (not illustrated) in this embodiment changes spins related to the corresponding element in order to set deltaV in the element 3001 to 0.

For example, as illustrated in FIG. 5, the matrix decomposition device 200 in this embodiment specifies a row number 3011 related to a row (nW) related to the element 3001, as a selected row number. Likewise, the matrix decomposition device 200 in this embodiment specifies a column number 3021 related to a column (nH) related to the element 3001, as a selected column number. In this manner, the matrix decomposition device 200 in this embodiment selects selected row number information and selected column number information based on, for example, the element having 1 as deltaV. Accordingly, no change is made to spins related to an element in which a difference does not occur, for example, an element having 0 as deltaV, and thus, the number of calculations may be reduced.

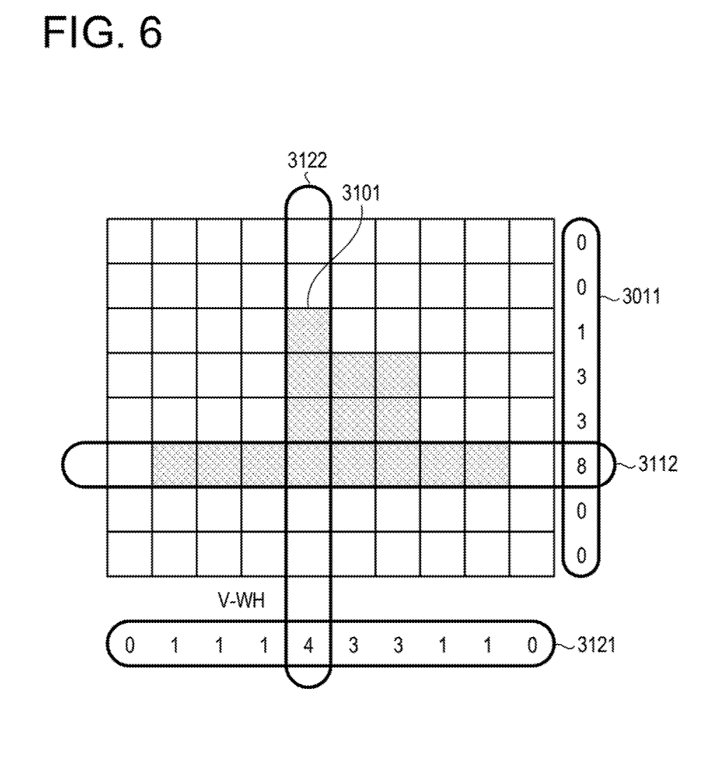

In FIG. 5, descriptions have been made on a case where, for example, there is one element having 1 as deltaV, but for example, when, there are a plurality of elements having 1 as deltaV, it is possible to select selected row number information and selected column number information according to the number of elements having 1 as deltaV. FIG. 6 is a view illustrating an example of a matrix decomposition processing progress in the second embodiment. FIG. 6 illustrates, for example, the number of elements having 1 as deltaV in each row and each column, in the form of a histogram. In FIG. 6, shaded elements 3101 indicate, for example, elements having 1 as deltaV. The number 3111 indicates the number of elements having 1 as deltaV in each row. Likewise, the number 3121 indicates the number of elements having 1 as deltaV in each column.

In this embodiment, the matrix decomposition device 200 selects the top p1 rows having a large number of elements having 1 as deltaV, among the respective rows. FIG. 6 illustrates, for example, a case where p1=1, in which a row 3112 having the largest number of elements having 1 as deltaV is selected. Likewise, in this embodiment, the matrix decomposition device 200 selects the top p2 columns having a large number of elements having 1 as deltaV, among the respective columns. FIG. 6 illustrates, for example, a case where p2=1, in which a column 3122 having the largest number of elements having 1 as deltaV is selected.

As described above, in this embodiment, the matrix decomposition device 200 selects the spins of rows and columns having many elements having 1 as deltaV, as change targets. Accordingly, no change is made to spins related to rows and columns having fewer differences, for example, a small number of elements having 1 as deltaV and thus, the number of calculations may be reduced.

[Processing Flow]

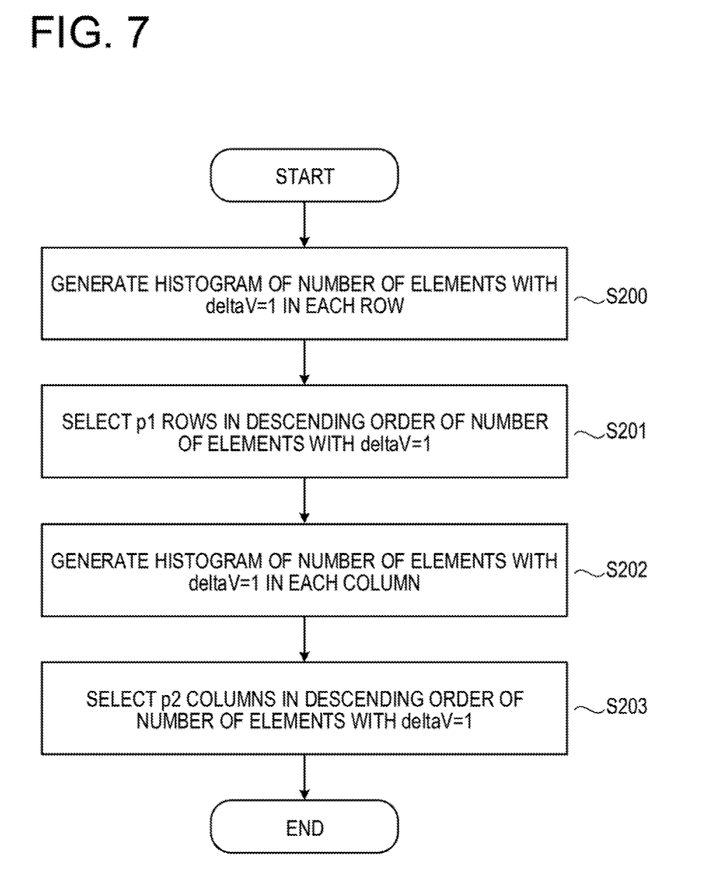

Hereinafter, descriptions will be made on a process in this embodiment, with reference to FIG. 7. FIG. 7 is a flowchart illustrating an example of a change spin selecting process in the second embodiment. FIG. 7 illustrates the details of the processing in S132 in FIG. 3A.

As illustrated in FIG. 7, the matrix decomposition device 200 in this embodiment generates a histogram of the number of elements having 1 as deltaV in each row as illustrated in FIG. 6 (S200). Then, the matrix decomposition device 200 selects p1 rows in a descending order of the number of elements having 1 as deltaV (S201).

Likewise, the matrix decomposition device 200 generates a histogram of the number of elements having 1 as deltaV in each column (S202). Then, the matrix decomposition device 200 selects p2 columns in descending order of the number of elements having 1 as deltaV (S203).

[Effect]

As described above, the matrix decomposition device in this embodiment performs a selection as selected column number information based on a difference between a product of a first matrix and a second matrix and a matrix as a decomposition target, and performs a selection as selected row number information based on a difference between the product of the first matrix and the second matrix, and the matrix as the decomposition target. Accordingly, a calculation amount may be reduced.

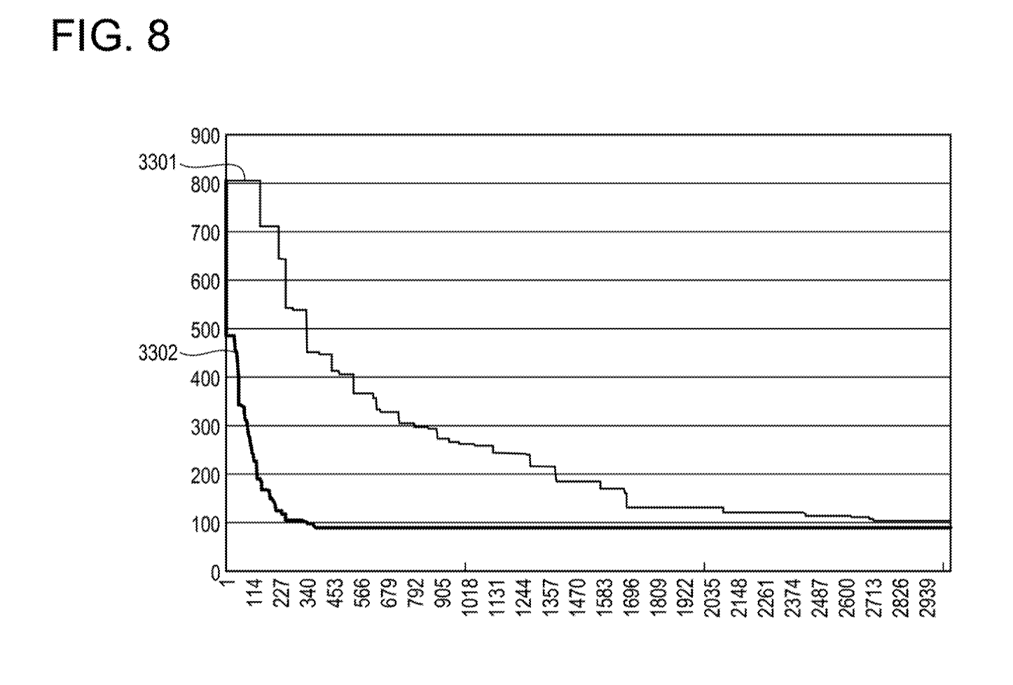

The effect of the matrix decomposition processing in this embodiment will be described with reference to FIG. 8. FIG. 8 is a view illustrating an example of comparison of matrix decomposition processing speeds. FIG. 8 illustrates a graph plotting an energy variation in a simulated/annealing process, in which a vertical axis indicates the energy, and a horizontal axis indicates an iteration count.

In FIG. 8, a graph 3301 indicates an energy variation in the case where spins to be changed are selected by using a uniform random number, and a graph 3302 indicates an energy variation in the case where spins to be changed are selected based on elements having 1 as deltaV. As illustrated in FIG. 8, when the spins to be changed are selected based on the elements having 1 as deltaV, it is possible to lower an energy by a small number of calculations as compared to a case where a uniform random number is used.

### Third Embodiment

In the above embodiment, descriptions have been made on a configuration in which a product of a first matrix and a second matrix, as a product by Boolean algebra, is calculated. However, an embodiment of the matrix decomposition device is not limited thereto, but may also be applied to, for example, a case where the element values of each matrix satisfy a finite field system such as a residue system of 2. The matrix decomposition device may also be applied to a case where the element values of each matrix are discrete values, and satisfy an integer system. In this embodiment, descriptions will be made on a configuration where a matrix decomposition device 300 decomposes a matrix which may not satisfy a Boolean algebra system. The matrix decomposition device 300 may be implemented by the same configuration as the matrix decomposition device 100 as illustrated in FIG. 2, and thus detailed descriptions thereof will be omitted.

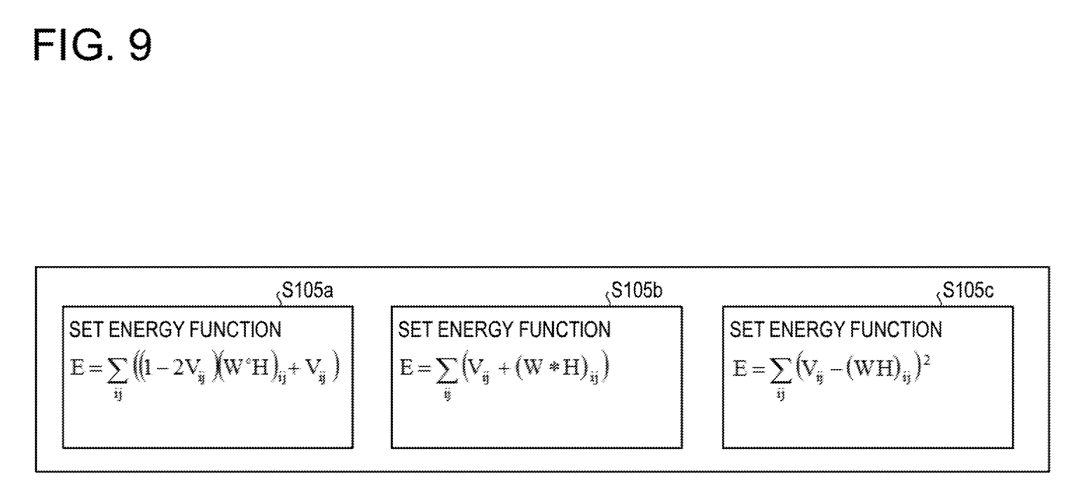

When the element values of a matrix are different, for example, the processing of generating an energy function E as indicated in S105 of FIG. 3A also differs according to the element values of the matrix. FIG. 9 is a view Illustrating examples of an energy function generation processing in the third embodiment. For example, as described with the first embodiment, when the element values of a matrix satisfy a Boolean algebra system, an energy function E is set by the equation (1) as indicated in S105a.

Meanwhile, for example, when the element values of a matrix satisfy a residue system of 2, Vᵢⱼ̂2=Vᵢⱼ and Vᵢⱼ×2=0 as in the Boolean algebra system. Therefore, when the element values of a matrix satisfy a residue system of 2, an energy function E is set by the equation as indicated in S105b.

For example, when the element values of a matrix are discrete values and satisfy an integer system, the lower limit calculation and the multiplication of Vᵢⱼ become an integer. In this case, an energy function E is set by the equation as indicated in S105c.

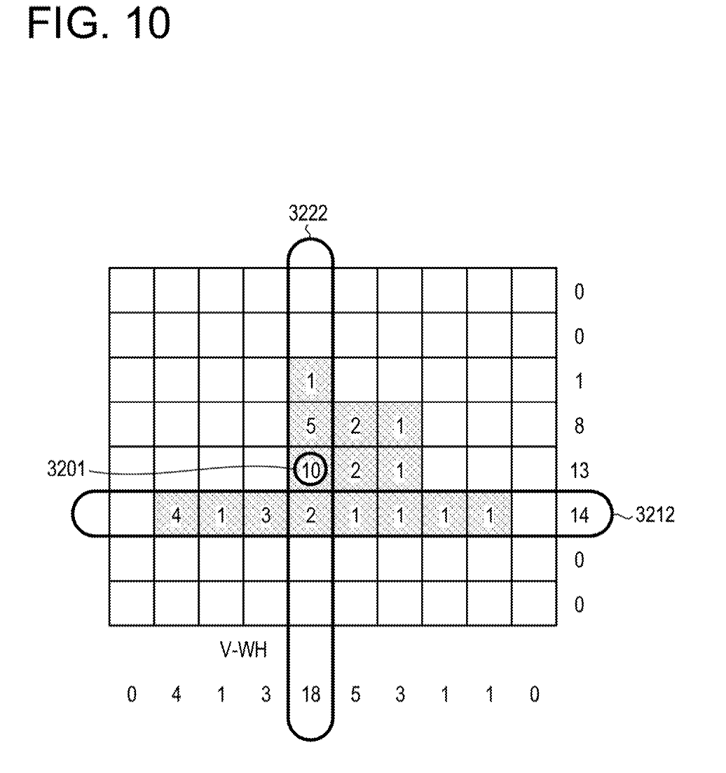

In the case where the element values of a matrix satisfy a residue system of 2, or satisfy an integer system as well, as described with the second embodiment, a row and a column as a selection target may be selected based on a difference between a product of a first matrix and a second matrix, and a matrix as a decomposition target. FIG. 10 is a view illustrating an example of a matrix decomposition processing progress in the third embodiment. FIG. 10 illustrates a cumulative total of deltaV of elements in each row and each column, in the form of a histogram, in the case where a matrix satisfying an integer system is decomposed. In FIG. 10, the value of deltaV may become not only 0 or 1, but also an integer. Thus, for example, as marked on an element 3201, the value of deltaV is marked on each of elements.

In this embodiment as well, the matrix decomposition device 300 selects the top p1 rows in which the cumulative total of deltaV values is large, among the respective rows. FIG. 10 illustrates, for example, a case where p1=1, in which a row 3212 having the highest cumulative total of deltaV values, “14,” is selected. Likewise, in this embodiment, the matrix decomposition device 300 selects the top p2 columns in which the cumulative total of deltaV values is large, among the respective columns. FIG. 10 illustrates, for example, a case where p2=1, in which a column 3222 having the highest cumulative total of deltaV values, “18,” is selected.

In the case where the element values satisfy a Boolean algebra system, or satisfy a residue system of 2, when a spin W or H is changed, “1” as an original value is changed to “0,” and “0” as an original value is changed to “1.” Meanwhile, in the case where the element values satisfy an integer system, when a spin W is changed, a uniform random number having a value that W may take may be generated, and a value not coinciding with a spin Wprev before changed may be adopted. Likewise, in the case where the element values satisfy an integer system, when a spin H is changed, a uniform random number having a value that H may take may be generated, and a value not coinciding with a spin Hprev before changed may be adopted.

[Effect]

As described above, in this embodiment, a product of an updated first matrix and an updated second matrix is, for example, a product by Boolean algebra, but is not limited thereto, and may be a product by a residue system of 2, or a matrix product. Accordingly, even when a matrix in which the element values may not satisfy a Boolean algebra system is decomposed, an inconsistency of elements may be suppressed.

### Fourth Embodiment

Meanwhile, focusing on the fact that it is difficult to decompose a matrix of discrete values whose element values satisfy a finite field system, for example, a cryptographic technique, such as a McEllece cryptosystem is used in which a matrix as a decomposition source is set as a public key, and a factor matrix is set as a secret key. The above-described matrix decomposition device may be used for decryption using a matrix as a decomposition source, as a public key, and a factor matrix, as a secret key.

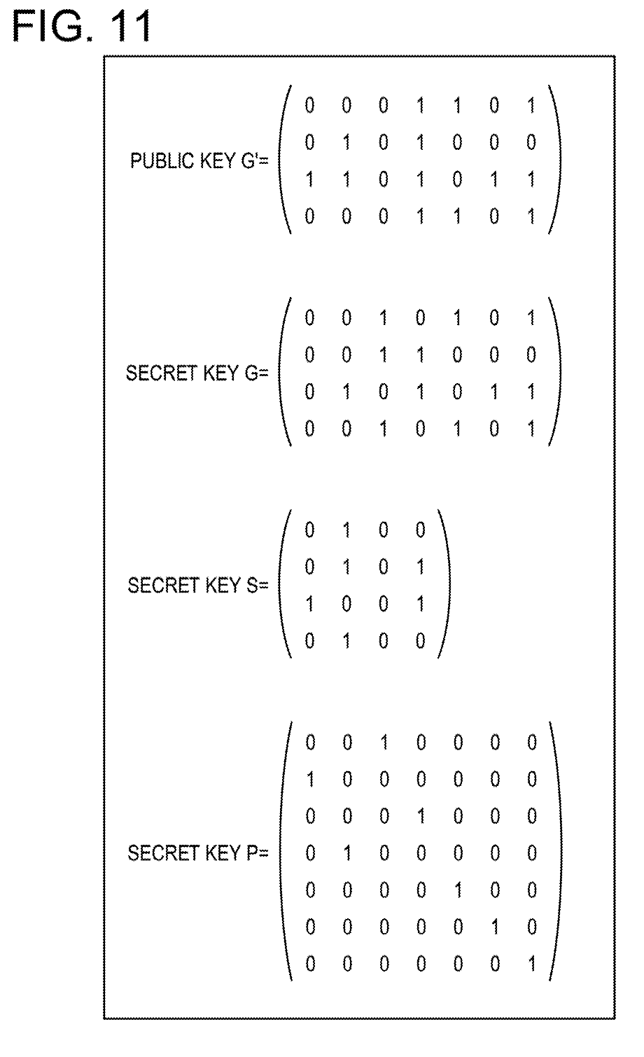

A matrix decomposition device 600 in this embodiment decomposes a matrix as a public key so as to specify matrices as secret keys as illustrated in FIG. 11. The matrix decomposition device 600 may be implemented by the same configuration as the matrix decomposition device 100 as illustrated in FIG. 2, and thus detailed descriptions thereof will be omitted. FIG. 11 is a view illustrating examples of a public key and a secret key in the fourth embodiment. In FIG. 11, a matrix G′ with k rows and n columns as a public key is a matrix obtained by multiplying a matrix S with k rows and k columns as a secret key by a matrix G with k rows and n columns as a secret key, and further by a matrix P with n rows and n columns as a secret key. The matrix decomposition device 600 (not illustrated) in this embodiment calculates secret keys G, S and P from the public key G′.

First, the matrix decomposition device 600 decomposes the matrix G′ as a decomposition target into the matrix S and a matrix Z as a product of the matrix G and the matrix P. Then, the matrix decomposition device 600 decomposes the matrix Z into the matrix G and the matrix P. The matrix S is an example of a first factor matrix, the matrix G is an example of a second factor matrix, and the matrix P is an example of a third factor matrix. The matrix Z is an example of a fourth factor matrix.

[Processing Flow]

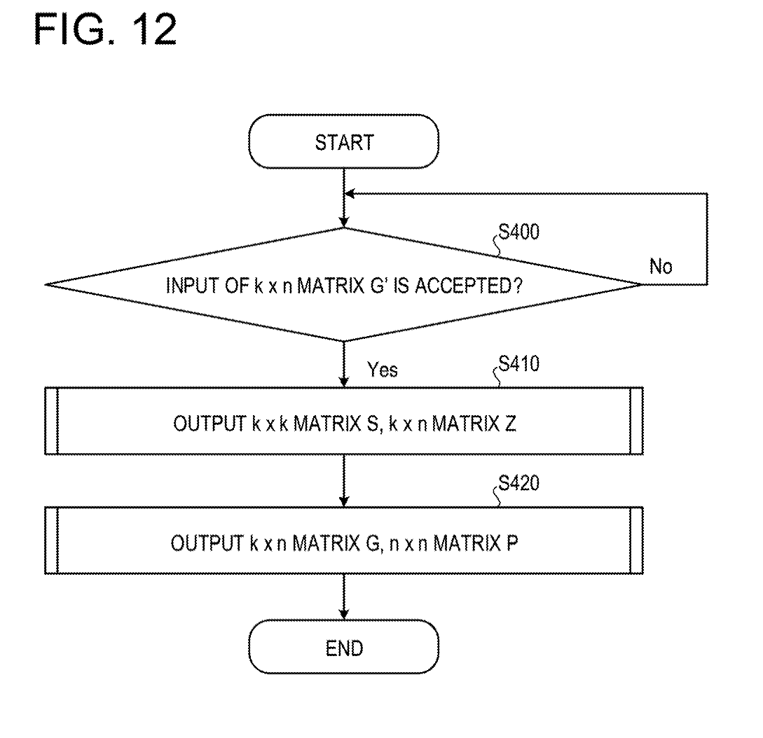

Next, a process in this embodiment will be described with reference to FIG. 12. FIG. 12 is a flowchart illustrating an example of a decryption process in the fourth embodiment. As illustrated in FIG. 12, the matrix decomposition device 600 in this embodiment waits until accepting an input of a matrix G′ with k rows and n columns through, for example, a communication unit or an input device (not illustrated) (S400: “No”).

When it is determined that the input of the matrix G′ has been accepted (S400: “Yes”), the matrix decomposition device 600 decomposes the matrix G′ into a matrix S with k rows and k columns and a matrix Z with k rows and n columns which satisfy that G′=SZ (S410). Here, the matrix decomposition device 600 outputs factor matrices S and Z by repeating processings S103 to S170 described in FIGS. 3A and 3B.

Thereafter, the matrix decomposition device 600 decomposes the matrix Z into a matrix G with k rows and n columns and a matrix P with n rows and n columns which satisfy that Z=GP (S420). Here, the matrix decomposition device 600 outputs factor matrices G and P by repeating processings S103 to S170 described in FIGS. 3A and 3B.

[Effect]

As described above, the matrix decomposition device in this embodiment decomposes a matrix as a decomposition target into a first factor matrix, a second factor matrix, and a third factor matrix. The matrix decomposition device generates an energy function based on the matrix as the decomposition target. The matrix decomposition device determines a temperature at which annealing is performed, based on an initial value of the temperature. The matrix decomposition device extracts information on a plurality of positions of elements which become non-zero elements in a matrix having, as an element, an absolute value of a difference obtained by subtracting a product of an updated first matrix and an updated fourth matrix from the matrix as the decomposition target. The matrix decomposition device determines the number of trials to change spins based on a first ranking number and the information on the plurality of positions. The matrix decomposition device calculates an updated energy function based on the updated first matrix and an updated second matrix according to the generated energy function, as many times as a predetermined iteration count. The matrix decomposition device changes a spin of a first matrix corresponding to selected column number information, and a spin of a second matrix corresponding to selected row number information, respectively, and then calculates a changed energy value by using the changed spin of the first matrix and the changed spin of the second matrix. When the changed energy value is smaller than an updated energy value, the matrix decomposition device repeats updating the updated energy value with the changed energy value, the first matrix including the changed spin of the first matrix, with the updated first matrix, and the second matrix including the changed spin of the second matrix, with the updated second matrix, respectively. When the product of the updated first matrix and the updated second matrix is equal to the matrix as the decomposition target, the matrix decomposition device sets the updated first matrix as the first factor matrix, and the updated second matrix as a fourth matrix. The matrix decomposition device repeats selecting information on one selected column number from information of a plurality of column numbers included in the information on the plurality of positions, and selecting information on one selected row number from information of a plurality of row numbers included in the information on the plurality of positions, as many times as the number of trials. The matrix decomposition device extracts information on a plurality of positions of elements which become non-zero elements in a matrix having, as an element, an absolute value of a difference obtained by subtracting a product of the updated fourth matrix and an updated third matrix from the matrix as the decomposition target. The matrix decomposition device determines the number of trials to change spins based on a second ranking number and the information on the plurality of positions. The matrix decomposition device calculates an updated energy function based on the updated fourth matrix and the updated third matrix according to the generated energy function, as many times as a predetermined iteration count. The matrix decomposition device changes a spin of the fourth matrix corresponding to selected column number information, and a spin of a third matrix corresponding to selected row number information, respectively, and then calculates a changed energy value by using the changed spin of the fourth matrix and the changed spin of the third matrix. When the changed energy value is smaller than an updated energy value, the matrix decomposition device repeats updating the updated energy value with the changed energy value, the fourth matrix including the changed spin of the fourth matrix, with the updated fourth matrix, and the third matrix including the changed spin of the third matrix, with the updated third matrix, respectively. When the product of the updated fourth matrix and the updated third matrix is equal to the matrix as the decomposition target, the matrix decomposition device sets the updated fourth matrix as the second factor matrix, and the updated third matrix as the third factor matrix. The matrix decomposition device repeats selecting information on one selected column number from information of a plurality of column numbers included in the information on the plurality of positions, and selecting to information on one selected row number from information of a plurality of row numbers included in the information on the plurality of positions, as many times as the number of trials. Accordingly, it is possible to easily decrypt secret keys of a cryptosystem based on matrix decomposition of discrete values such as, for example, McEliece cryptosystem, from a public key.

### Fifth Embodiment

Meanwhile, embodiments of the present disclosure have been described so far, but the present disclosure may be implemented by other various embodiments as well as the above described embodiments.

For example, in S110 of FIG. 3A, initial values W0 or H0 of spins are all set to “0,” or all set to “1,” but are not limited thereto. A matrix decomposition device 700 in this embodiment may set the initial value W0 or H0 of a spin such that, for example, the ratio of non-zero elements included in a product of factor matrices approximates the ratio of non-zero elements included in a matrix V as a decomposition target. For example, to the initial value W0 or H0 of a spin, a random number of 0 or 1 weighted by the ratio of non-zero elements included in the matrix V as the decomposition target may be allocated. This may reduce a difference between the product of matrices at the initial stage and the matrix as the decomposition target. The matrix decomposition device 700 in this embodiment may be implemented by the same configuration as the matrix decomposition device 100 as illustrated in FIG. 2, and thus detailed descriptions thereof will be omitted.

In the case where the ratio of non-zero elements in the matrix V is set as Y, a weighted random number may be generated by using a ratio obtained by multiplying Y by a coefficient r, and further by a ranking number k. In this case, the coefficient r is, for example, an average probability that an element generated by a random number becomes 1 by multiplication and addition. For example, when the element satisfies a Boolean algebra system, the coefficient r becomes 3/16 obtained by multiplying a probability 1/4 of occurrence of 1 by multiplication, by a probability 3/4 of occurrence of 1 by addition. Meanwhile, for example, when the element satisfies a residue system of 2, the coefficient r becomes 2/16 obtained by multiplying a probability 1/4 of occurrence of 1 by multiplication, by a probability 2/4 of occurrence of 1 by addition.

A uniform random number of 0 or 1 may be allocated to the initial values W0 and H0 of spins. A continuous value from 0 to 1 may be allocated to the initial values W0 and H0 of spins. In the case where initial values W0 and H0 of spins are all set to “0,” or “1” as well, for example, when the ratio of non-zero elements occurring in all elements included in the matrix V as the decomposition target is equal to or more than a half, “1” may be set, and when the ratio is less than a half, “0” may be set.

For example, when selecting selected column number information and selected row number information, the matrix decomposition device in this embodiment may use a uniform random number or a weighted random number as a random number. Accordingly, a simulated/annealing process may be optimized.

[Processing Flow]

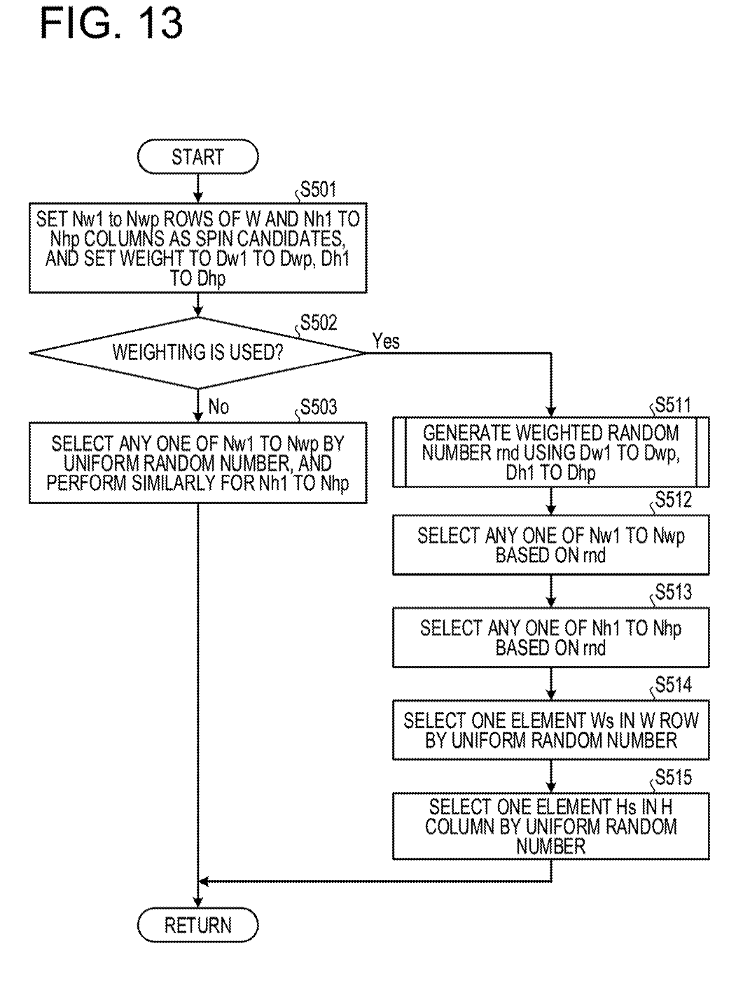

Descriptions will be made on the process of selecting the change spin by using a random number in S132 of FIG. 3A in this embodiment, with reference to FIG. 13 to FIG. 15. FIG. 13 is a flowchart illustrating an example of a change spin selecting process in the fifth embodiment. As illustrated in FIG. 13, the matrix decomposition device 700 in this embodiment selects Nw1 to Nwp rows of W, as spin candidates. The matrix decomposition device 700 selects Nh1 to Nhp columns of H, as spin candidates. In this case, the matrix decomposition device 700 sets a weight in each row to Dw1 to Dwp and sets a weight in each column to Dh1 to Dhp (S501).

Then, the matrix decomposition device 700 determines whether to use weighting when generating a random number (S502). When it is determined that weighting is not to be used (S502: “No”), the matrix decomposition device 700 generates a uniform random number, selects any one of the rows Nw1 to Nwp (S503), and proceeds to S133 in FIG. 3A.

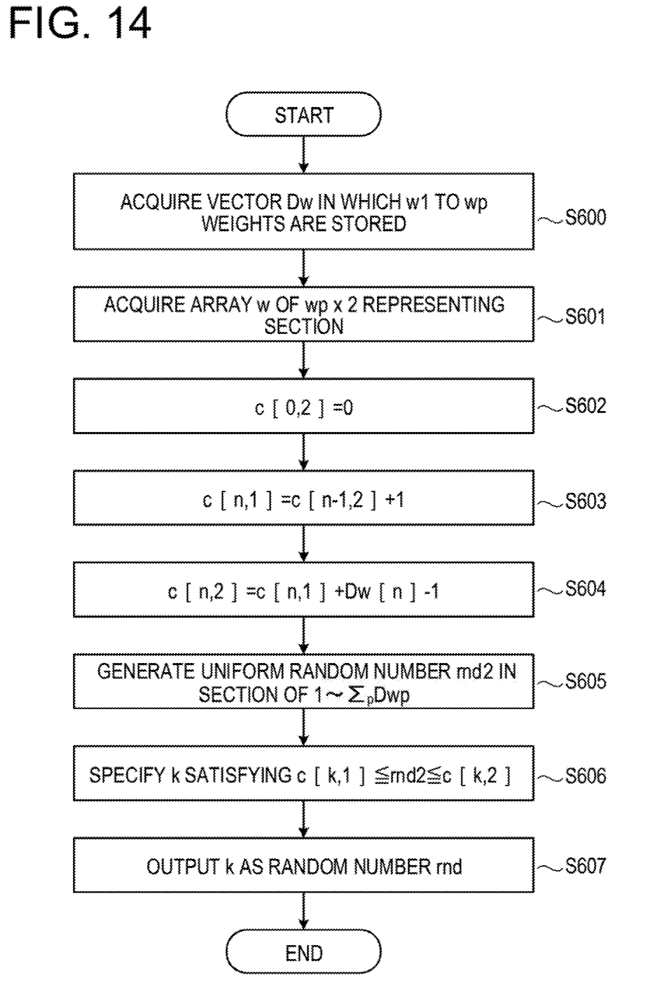

Meanwhile, when it is determined that weighting is to be used (S502: “Yes”), the matrix decomposition device 700 generates a weighted random number rnd by using the weights Dw1 to Dwp and Dh1 to Dhp (SS511). A processing of generating rnd will be described below with reference to FIG. 14.

The matrix decomposition device 700 selects any one of the rows Nw1 to Nwp based on the generated rnd (S512). Likewise, the matrix decomposition device 700 selects any one of the columns Nh1 to Nhp based on the generated rnd (S513).

Thereafter, the matrix decomposition device 700 selects any one element Ws included in the selected row by using the uniform random number (S514). Likewise, the matrix decomposition device 700 selects any one element Hs included in the selected column by using the uniform random number (S515), and proceeds to S133 in FIG. 3A.

Hereinafter, details of the processing of generating the random number rnd in S511 will be described with reference to FIG. 14. FIG. 14 is a flowchart illustrating an example of a random number generation process in the fifth embodiment. As illustrated in FIG. 14, the matrix decomposition device 700 acquires a vector Dw in which the weights Dw1 to Dwp are stored (S600). Then, the matrix decomposition device 700 acquires an array w of wpx2 representing a section corresponding to sizes of the weights Dw1 to Dwp, respectively (S601). For example, when the weights Dw1 to Dwp are “3,3,5,” respectively, the array w satisfies that c“1,1”=1. Likewise, c[1,2]=3, c[2,1]=4, c[2,2]=6, c[3,1]=7, and c[3,2]=11.

Thereafter, the matrix decomposition device 700 sets c[0,2] to 0 (S602), and sets c[n,1] to c[n−1,2]+1 for 1 to p (S603). Likewise, the matrix decomposition device 700 sets c[n,2] to c[n,1]+Dw[n]−1 (c[n,2]=c[n,1]+Dw[n]−1) (S604).

Then, the matrix decomposition device 700 generates a uniform random number rnd2 in the section between 1 to ΣₚDwp (S605). The matrix decomposition device 700 specifies k satisfying that c[k,1]≤rnd2≤c[k,2] (S606), and outputs k as a random number rnd (S607).

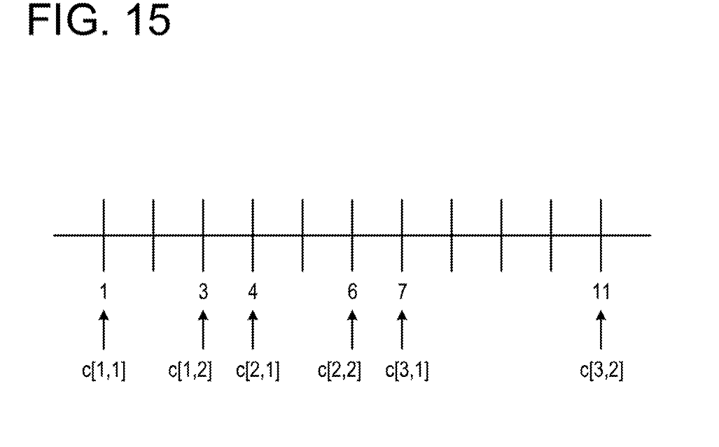

FIG. 15 is a view illustrating an example of a random number generation result in the fifth embodiment. In FIG. 15, for example, when rnd2 is “5,” rnd2 is c[2,1] or more, and c[2,2] or less. In this case, the matrix decomposition device 700 generates k=2 as the random number md. Accordingly, it is possible to generate a random number reflecting the weight as Illustrated in FIG. 6 or FIG. 10.

[Temperature Calculation Processing]

In the above-described embodiment, in the processing of calculating the temperature T as indicated in S112 of FIG. 3A, as expressed in the equation (3), the reciprocal of the logarithm of an iteration count is calculated as the temperature T, but an embodiment is not limited thereto. For example, the temperature may be set as the reciprocal of an iteration count so that the temperature may be gradually reduced. The temperature may be set as the reciprocal of the index of an iteration count so that the temperature may be rapidly reduced.

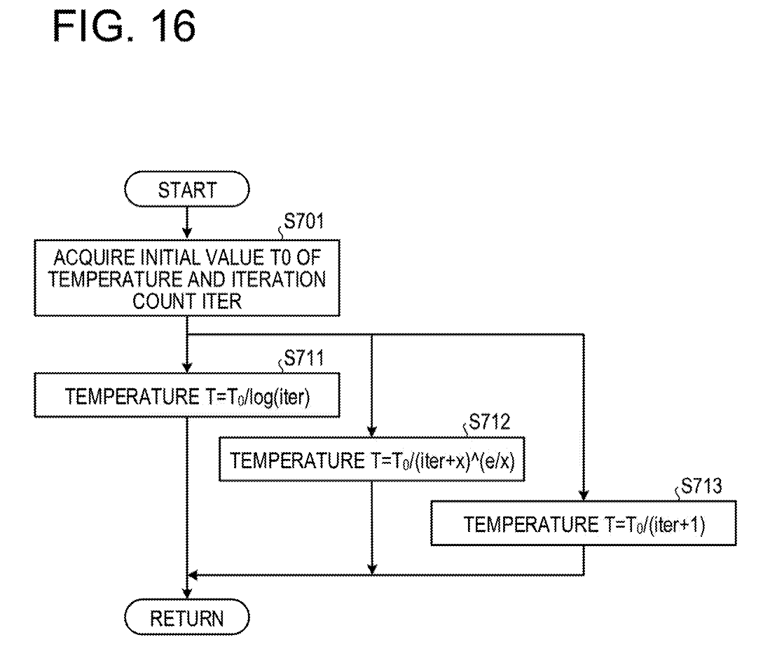

Details of the processing in S112 of FIG. 3A will be described with reference to FIG. 16. FIG. 16 is a flowchart illustrating an example of a temperature calculation process in the fifth embodiment. As illustrated in FIG. 16, the temperature controller 135 acquires an initial value T0 of a temperature, and an iteration count iter (S701). Then, the temperature controller 135 calculates, for example, the reciprocal of the logarithm of an iteration count as expressed by equation (3), as the temperature T (S711). Meanwhile, the temperature controller 135 may calculate the reciprocal of the index of an iteration count, as the temperature T (S712). The temperature controller 135 may calculate the reciprocal of an iteration count, as the temperature T (S713).

[Value of Spin s]

In the above-described embodiment, descriptions have been made on an example where the value of a spin s is {0,1}, but an embodiment is not limited thereto. For example, 6 which may take a value such as {−1,1} may be set as a spin value. The relationship between such a value of the spin δ and a value of the spin s is expressed by, for example, an equation such as s=(δ+1)/2.

[System]

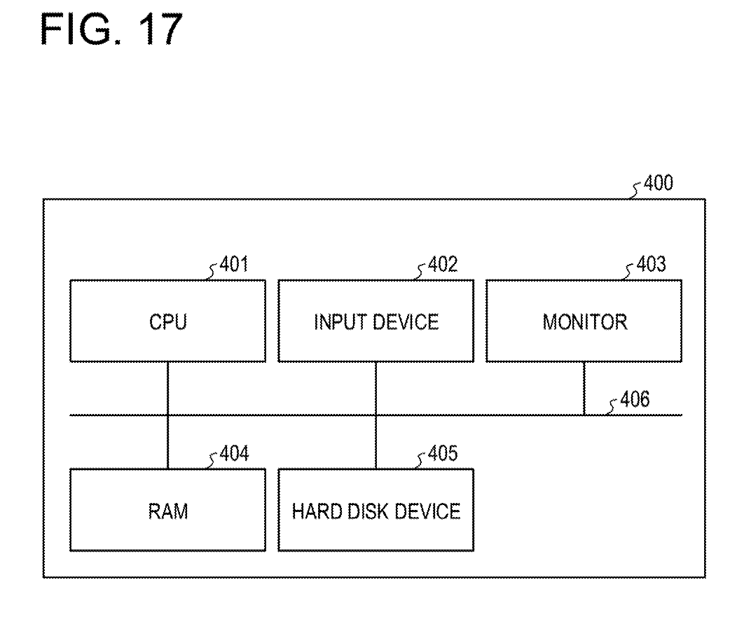

Hereinafter, descriptions will be made on an example of a computer that executes a matrix decomposition program described in the above embodiments. FIG. 17 is a view illustrating an example of a hardware configuration of a matrix decomposition device. As illustrated in FIG. 17, a computer 400 includes a CPU 401 that executes various arithmetic processings, an input device 402 that accepts a data input from a user, and a monitor 403. The computer 400 includes a random access memory (RAM) 404 which temporarily stores various information, and a hard disk device 405. The respective devices 401 to 405 are connected to a bus 406.

The hard disk device 405 stores, for example, information processing programs having the same functions as the respective processors as Illustrated in FIG. 2. The hard disk device 405 stores various data for implementing the information processing programs.

The CPU 401 reads the respective programs stored in the hard disk device 405, and develops and executes the programs in the RAM 404 to perform various processings. These programs may cause the computer 400 to function as each of the processors illustrated in FIG. 2.

The above described information processing programs may not be necessarily stored in the hard disk device 405. For example, the computer 400 may be caused to read and execute programs stored in a storage medium readable by the computer 400. The storage medium readable by the computer 400 corresponds to, for example, a portable recording medium such as a CD-ROM, a DVD disk, or a universal serial bus (USB) memory, a semiconductor memory such as a flash memory or a hard disk drive. These programs may be stored in a device connected to, for example, a public line, the Internet, or a local area network (LAN), and the computer 400 may be caused to read and execute the programs from these.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A matrix decomposition device configured to decompose a matrix as a decomposition target into a first factor matrix and a second factor matrix, the matrix decomposition device comprising:
a memory; and
a processor coupled to the memory and the processor configured to:
generate an energy function based on the matrix as the decomposition target;
determine a temperature at which annealing is performed, based on an initial value of the temperature;
extract information on a plurality of positions where elements become 1 in a matrix having, as an element, an absolute value of a difference obtained by subtracting a product of an updated first matrix and an updated second matrix from the matrix as the decomposition target, and determine a number of trials to change spins based on a ranking number and the information on the plurality of positions;
calculate an updated energy function based on the updated first matrix and the updated second matrix according to the generated energy function, as many times as a predetermined iteration count, change a spin of a first matrix corresponding to selected column number information, and a spin of a second matrix corresponding to selected row number information, respectively, calculate a changed energy value by using the changed spin of the first matrix and the changed spin of the second matrix, when the changed energy value is smaller than an updated energy value, repeat updating the updated energy value with the changed energy value, the first matrix including the changed spin of the first matrix, with the updated first matrix, and the second matrix including the changed spin of the second matrix, with the updated second matrix, respectively, and when the product of the updated first matrix and the updated second matrix is equal to the matrix as the decomposition target, set the updated first matrix as the first factor matrix, and the updated second matrix as the second factor matrix; and
repeat selecting information on one selected column number from information of a plurality of column numbers included in the information on the plurality of positions, and selecting information on one selected row number from information of a plurality of row numbers included in the information on the plurality of positions, as many times as the number of trials.

2. The matrix decomposition device according to claim 1, wherein the processor is configured to select the selected column number information based on a random number, and selects the selected row number information based on the random number.

3. The matrix decomposition device according to claim 2, wherein the random number is a uniform random number.

4. The matrix decomposition device according to claim 2, wherein the random number is a weighted random number.

5. The matrix decomposition device according to claim 1, wherein the processor is configured to perform selection as the selected column number information based on a difference between a product of the first matrix and the second matrix, and the matrix as the decomposition target, and selection as the selected row number information based on the difference between the product of the first matrix and the second matrix, and the matrix as the decomposition target.

6. The matrix decomposition device according to claim 1, wherein the product of the updated first matrix and the updated second matrix is a product by Boolean algebra.

7. The matrix decomposition device according to claim 1, wherein the product of the updated first matrix and the updated second matrix is a product by a residue system of 2.

8. The matrix decomposition device according to claim 1, wherein the product of the updated first matrix and the updated second matrix is a matrix product.

9. The matrix decomposition device according to claim 1, wherein the processor is configured to set an initial value of the first matrix and an initial value of the second matrix such that a ratio of non-zero elements in a product of the first matrix before updated and the second matrix before updated approximates a ratio of non-zero elements in the matrix as the decomposition target.

10. The matrix decomposition device according to claim 1 wherein when the changed energy value is larger than the updated energy value, the processor is configured to generate a random number by using the temperature determined by the processor, at which the annealing is performed, and when the random number is equal to or greater than a predetermined probability value, the processor is configured to update the updated energy value with the changed energy value, the first matrix including the changed spin of the first matrix, with the updated first matrix, and the second matrix including the changed spin of the second matrix, with the updated second matrix, respectively.

11. A matrix decomposition device configured to decompose a matrix as a decomposition target into a first factor matrix, a second factor matrix, and a third factor matrix, the matrix decomposition device comprising:
a memory; and
a processor coupled to the memory and the processor configured to:
generate an energy function based on the matrix as the decomposition target;
determine a temperature at which annealing is performed, based on an initial value of the temperature;
extract information on a plurality of positions of elements which become non-zero elements in a matrix having, as an element, an absolute value of a difference obtained by subtracting a product of an updated first matrix and an updated fourth matrix from the matrix as the decomposition target, and determine a number of trials to change spins based on a ranking number and the information on the plurality of positions;
calculate an updated energy function based on the updated first matrix and the updated fourth matrix according to the generated energy function, as many times as a predetermined iteration count, changes a spin of a first matrix corresponding to selected column number information, and a spin of a fourth matrix corresponding to selected row number information, respectively, calculate a changed energy value by using the changed spin of the first matrix and the changed spin of the fourth matrix, when the changed energy value is smaller than an updated energy value, repeat updating the updated energy value with the changed energy value, the first matrix including the changed spin of the first matrix, with the updated first matrix, and the fourth matrix Including the changed spin of the fourth matrix, with the updated fourth matrix, respectively, and when the product of the updated first matrix and the updated fourth matrix is equal to the matrix as the decomposition target, set the updated first matrix as the first factor matrix, and the updated fourth matrix as a fourth factor matrix; and
repeat selecting information on one selected column number from information of a plurality of column numbers included in the information on the plurality of positions, and selecting information on one selected row number from information of a plurality of row numbers included in the information on the plurality of positions, as many times as the number of trials,
wherein the processor extract information on a plurality of positions of elements which become non-zero elements in a matrix having, as an element, an absolute value of a difference obtained by subtracting a product of an updated second matrix and an updated third matrix from the fourth factor matrix, and determine a number of trials to change spins based on the ranking number and the information on the plurality of positions,
the processor calculates an updated energy function based on the updated second matrix and the updated third matrix according to the generated energy function, as many times as a predetermined iteration count, changes a spin of a second matrix corresponding to selected column number information, and a spin of a third matrix corresponding to selected row number information, respectively, calculates a changed energy value by using the changed spin of the second matrix and the changed spin of the third matrix, when the changed energy value is smaller than an updated energy value, repeats updating the updated energy value with the changed energy value, the second matrix including the changed spin of the second matrix, with the updated second matrix, and the third matrix including the changed spin of the third matrix, with the updated third matrix, respectively, and when the product of the updated second matrix and the updated third matrix is equal to the fourth factor matrix, sets the updated second matrix as the second factor matrix, and the updated third matrix as the third factor matrix, and
the processor repeats selecting information on one selected column number from information of a plurality of column numbers included in the information on the plurality of positions, and selecting information on one selected row number from information of a plurality of row numbers included in the information on the plurality of positions, as many times as the number of trials.

12. A matrix decomposition method configured to decompose a matrix as a decomposition target into a first factor matrix and a second factor matrix, the matrix decomposition method comprising:
generating an energy function based on the matrix as the decomposition target;
determining a temperature at which annealing is performed, based on an initial value of the temperature;
extracting information on a plurality of positions where elements become 1 in a matrix having, as an element, an absolute value of a difference obtained by subtracting a product of an updated first matrix and an updated second matrix from the matrix as the decomposition target, and determine a number of trials to change spins based on a ranking number and the information on the plurality of positions;
calculating an updated energy function based on the updated first matrix and the updated second matrix according to the generated energy function, as many times as a predetermined iteration count, change a spin of a first matrix corresponding to selected column number information, and a spin of a second matrix corresponding to selected row number information, respectively, calculate a changed energy value by using the changed spin of the first matrix and the changed spin of the second matrix, when the changed energy value is smaller than an updated energy value, repeat updating the updated energy value with the changed energy value, the first matrix including the changed spin of the first matrix, with the updated first matrix, and the second matrix including the changed spin of the second matrix, with the updated second matrix, respectively, and when the product of the updated first matrix and the updated second matrix is equal to the matrix as the decomposition target, set the updated first matrix as the first factor matrix, and the updated second matrix as the second factor matrix; and
repeating selecting information on one selected column number from information of a plurality of column numbers included in the information on the plurality of positions, and selecting information on one selected row number from information of a plurality of row numbers included in the information on the plurality of positions, as many times as the number of trials, by a processor.
